(19) United States
(12) Patent Application Publication
(10) Pub. No.: US 2024/0326496 A1
(43) Pub. Date: Oct. 3, 2024

(54) IMAGE PROCESSING APPARATUS, IMAGE PROCESSING METHOD, AND STORAGE MEDIUM

(71) Applicant: RISO KAGAKU CORPORATION, Tokyo (JP)

(72) Inventors: Takahisa YAMAZAKI, Tokyo (JP); Takahiko NAKAMURA, Tokyo (JP); Yuki URANO, Tokyo (JP)

(21) Appl. No.: 18/615,738

(22) Filed: Mar. 25, 2024

(30) Foreign Application Priority Data
Mar. 29, 2023 (JP) 2023-053302

(51) Int. Cl. B41J 29/393; B41J 2/21

(52) U.S. Cl. CPC B41J 29/393; B41J 2/2107; B41J 2029/3935; B41J 2203/01

(57) ABSTRACT

An image processing apparatus includes a processor being configured to extract characteristic information of a printed material corresponding to a base material used for printing using pretreatment liquid, base ink, and color ink and a printing condition of the printing, and to generate a characteristic information image representing the extracted characteristic information.

### CROSS-REFERENCE TO RELATED APPLICATION

This application is based upon and claims the benefit of priority of the prior Japanese Patent Application No. 2023-053302 filed on Mar. 29, 2023, the entire contents of which are incorporated herein by reference.

### FIELD

Embodiments discussed herein are related to an image processing apparatus, an image processing method, and a storage medium.

### BACKGROUND

Heretofore, a method has been proposed in which a user can check a print image and printing conditions in advance before printing is actually performed (see, for example, JP 2002-132165 A, JP 2007-316316 A, and JP 2013-125329 A).

### SUMMARY

According to one aspect, an image processing apparatus includes a processor being configured to extract characteristic information of a printed material corresponding to a base material used for printing using pretreatment liquid, base ink, and color ink and a printing condition of the printing, and to generate a characteristic information image representing the extracted characteristic information.

An object and advantages of the invention will be realized and attained by means of the elements and combinations particularly pointed out in the claims.

### BRIEF DESCRIPTION OF THE DRAWINGS

FIG. 1 is a diagram illustrating control configurations of a printing control apparatus and a printing apparatus according to an embodiment;

FIG. 2 is a diagram illustrating the printing apparatus according to the embodiment;

FIG. 3 is a diagram illustrating a test print screen according to the embodiment;

FIG. 4 is a diagram illustrating an advanced setting screen (part 1) according to the embodiment;

FIG. 5 is a diagram illustrating an advanced setting screen (part 2) according to the embodiment;

FIG. 6 is a diagram illustrating a test print image (part 1) according to the embodiment;

FIG. 7 is a diagram illustrating a test print image (part 2) according to the embodiment; and

FIG. 8 is a diagram illustrating a base material (printed material) on which a test print image (part 3) according to the embodiment is printed.

### DETAILED DESCRIPTION

Meanwhile, when printing is performed on a colored base material, for example, a base material such as a colored cloth, printing may be performed by applying pretreatment liquid containing a component that causes aggregation of ink, then applying white ink to form a white layer, and then applying color ink on it. In this case, the white layer has a role of clearing a color image formed on the white layer by hiding the color of the base material. At that time, depending on the characteristics such as the material of the cloth and the color of the cloth, how much pretreatment liquid and how much white ink that should be applied to make a clear image and a good durability (fastness to washing) are different. For example, since a polyester material has a property that pretreatment liquid or white ink easily permeates the inside of the cloth, if the amount of the pretreatment or the white ink is small, the amount of ink formed so as to cover the cloth decreases, and thus a white hiding ratio (white density) decreases, and the pattern obtained by the printing result is affected by the color of the base material. In the case of a cotton material, since the cotton material has a property that the pretreatment liquid or the white ink is absorbed by fibers on the surface of the cloth and tends to remain in the vicinity of the surface of the cloth, a high white hiding ratio tends to be obtained as compared with the polyester material even if the amount of the pretreatment liquid or the white ink is small.

Meanwhile, if the amount of the pretreatment liquid with respect to the white ink is too small, the pretreatment liquid becomes so insufficient to aggregate the white ink that the white ink penetrates into the cloth. Therefore, the white hiding ratio is lowered. On the other hand, if the amount of the pretreatment liquid with respect to the white ink is too large, the power to aggregate the white ink is too strong, which cracks the white ink and decreases the durability (e.g., fastness to washing).

Meanwhile, there are many factors that change the white hiding ratio and the fastness to washing, such as not only the material and color of the fiber but also the dye used for coloring, the thickness of the fiber, the density, the way of knitting, and the thickness of the cloth. Therefore, even if the manufacturer indicates a guide of conditions (amount of liquid) for a standard cloth, there is a problem that in the case of using an unknown cloth, optimal conditions for each cloth cannot be known unless image quality is checked by actual printing and durability is checked by actual washing.

As described above, conventionally, the user has not been able to easily find the optimum or preferred printing conditions corresponding to the characteristic information of the printed material after printing such as the fastness to washing and the white density.

Hereinafter, an image processing apparatus, an image processing method, and a program according to an embodiment of the present invention will be described with reference to the drawings using a printing control apparatus, a printing control method, and a program as an example.

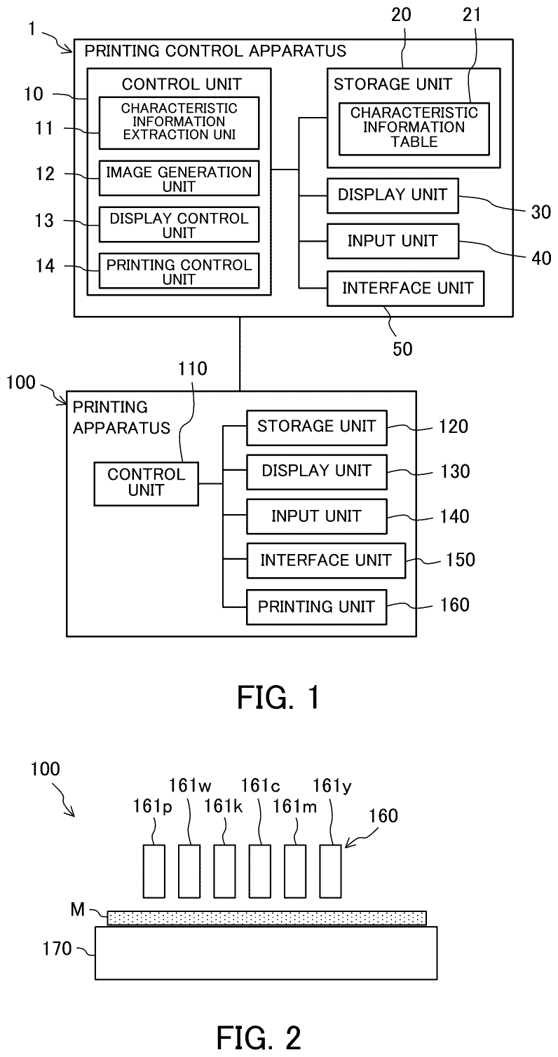

FIG. 1 is a diagram illustrating control configurations of a printing control apparatus 1 and a printing apparatus 100 according to the embodiment.

As illustrated in FIG. 1, the printing control apparatus 1 that is an example of the image processing apparatus includes a control unit 10, a storage unit 20, a display unit 30, an input unit 40, and an interface unit 50. A system including the printing control apparatus 1 and the printing apparatus 100 can be regarded as a printing system. The printing control apparatus 1 may be an apparatus dedicated to control the printing apparatus 100, or may be an apparatus such as a user terminal (e.g., a tablet device, a smartphone, a notebook computer, or a desktop computer). Note that, the image processing apparatus according to the present embodiment is not limited to the printing control apparatus 1, and may be an apparatus that does not control the printing apparatus 100, or may be the printing apparatus 100 itself. A system including such an image processing apparatus and the printing apparatus 100 can also be regarded as a printing system.

The control unit 10 includes, for example, one or more processors (such as a central processing unit (CPU)) functioning as an arithmetic processing device that controls the operation of each unit of the printing control apparatus 1. This processor functions as, for example, a characteristic information extraction unit 11, an image generation unit 12, a display control unit 13, and a printing control unit 14 by reading and executing a predetermined program from the storage unit 20 or from a storage medium (non-transitory computer-readable recording medium) attachable to and detachable from the printing control apparatus 1. As described above, the control unit 10 or the printing control apparatus 1 (the control unit 10 and the storage unit 20) functions as a computer that executes a program.

The characteristic information extraction unit 11 extracts, from a characteristic information table 21 of the storage unit 20, for example, characteristic information of a printed material corresponding to a base material M (see FIG. 2) used for printing using pretreatment liquid, white ink (an example of base ink), and color ink and printing conditions of this printing, for each of the multiple printing conditions. Here, the printed material can be referred to as the base material M in a printed state. Further, the color ink can be referred to as ink of one or more colors other than the base ink.

The printing conditions are, for example, the amounts of the pretreatment liquid and the white ink, the ratio between the pretreatment liquid and the white ink, and the like. Further, in the present invention, the characteristic information refers to characteristics other than image quality, and is, for example, information related to matters other than the finish of printing including durability such as fastness to washing (at least one of discoloration and contamination) and fastness to rubbing (at least one of discoloration and contamination), cost, and the total usage amount of the pretreatment liquid and the white ink, or information related to the finish of printing including white density and texture. The cost is, for example, cost required for the pretreatment liquid and the white ink, or cost required when ink of another color is added in addition to the pretreatment liquid and the white ink. When the amount of the pretreatment liquid or the white ink increases, the cost may increase, or the time required for printing may increase. In the case of similar image quality and durability, it is preferable to use liquid with a smaller usage amount, but it is difficult for the user to find it. Thus, the characteristic information preferably includes the above-described cost, the total usage amount of the pretreatment liquid and the white ink, and the like in addition to the fastness to washing and the white density to be described below.

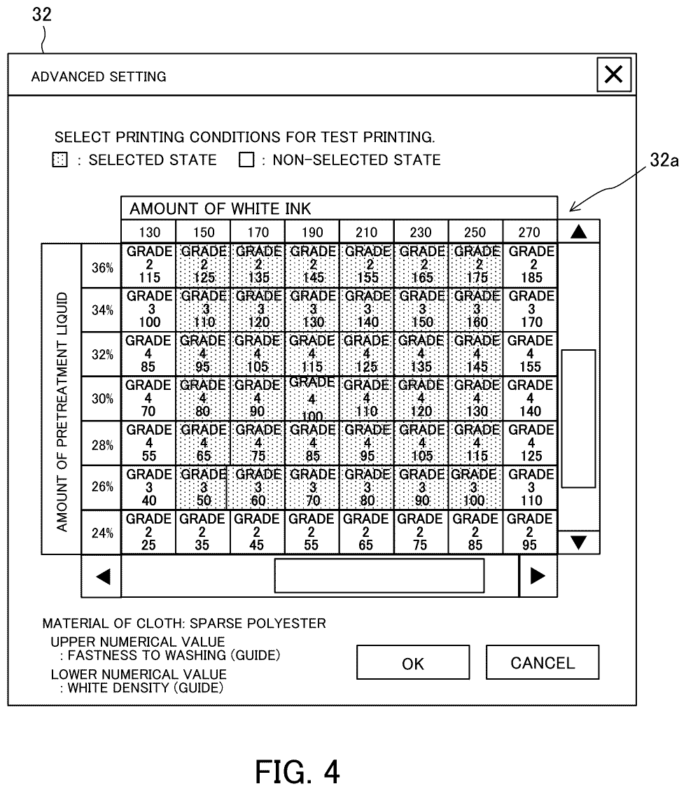

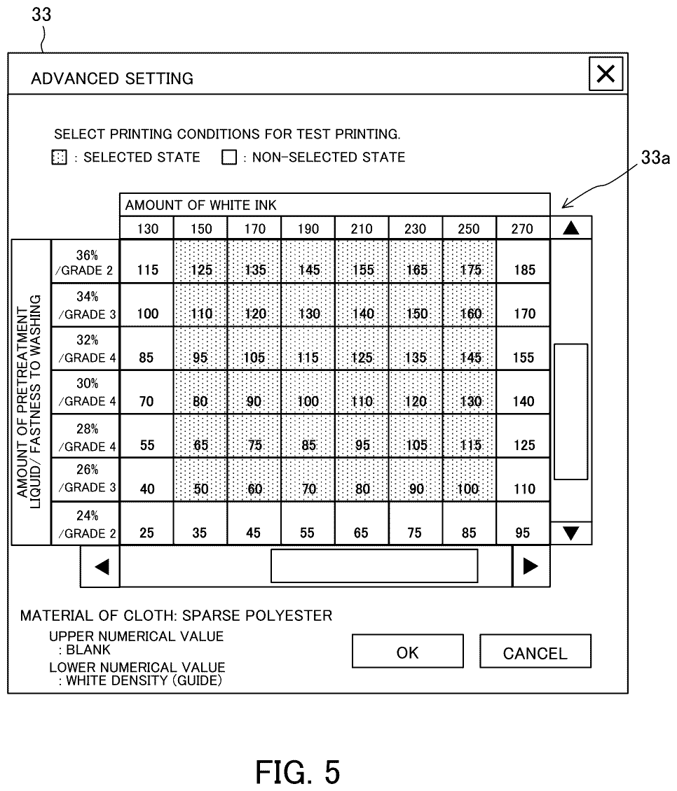

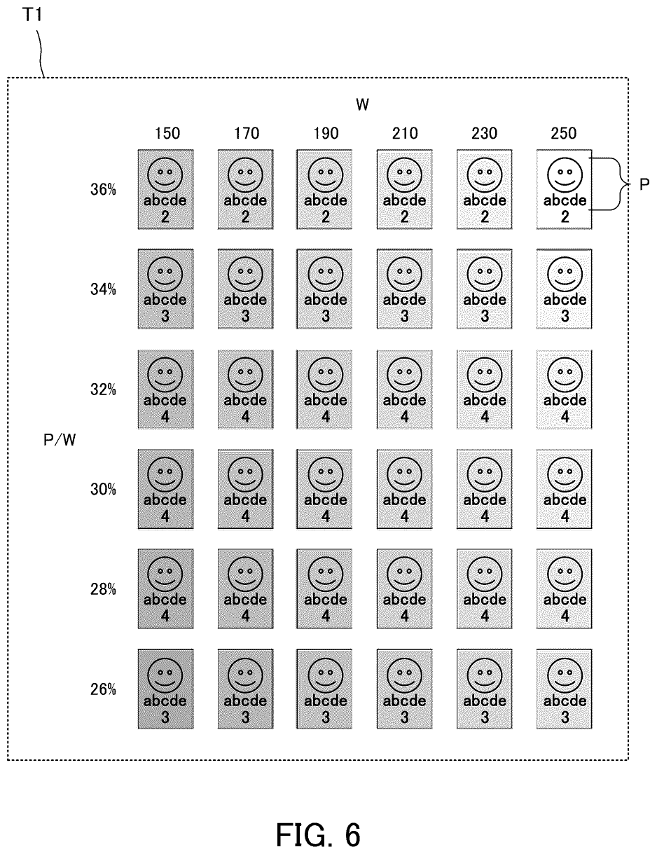

The image generation unit 12 generates a characteristic information image representing the characteristic information extracted by the characteristic information extraction unit 11. As will be described later, the characteristic information image is, for example, test print images T1 to T3 illustrated in FIGS. 6 to 8 or condition selection images 32a and 33a illustrated in FIGS. 4 and 5. The characteristic information image may represent a single printing condition and characteristic information corresponding to this printing condition, but preferably represents multiple printing conditions and characteristic information corresponding to each of the multiple printing conditions so that the user can select a preferable condition from the multiple conditions.

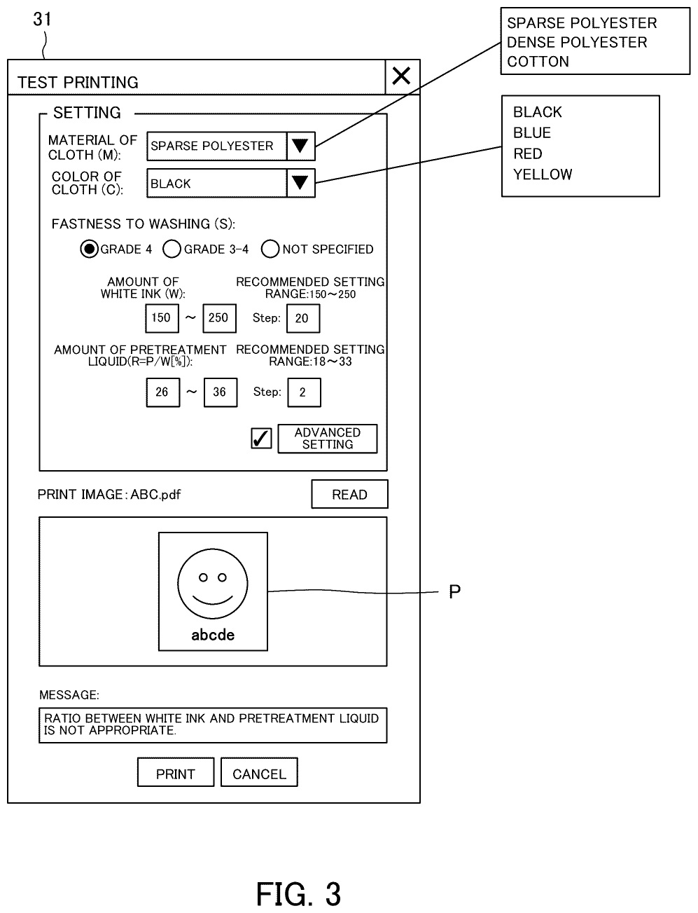

The display control unit 13 performs control to display, on the display unit 30, the above-described characteristic information image (the test print images T1 to T3 and the condition selection images 32a and 33a) generated by the image generation unit 12, a test print screen 31 illustrated in FIG. 3, advanced setting screens 32 and 33 illustrated in FIGS. 4 and 5, and the like.

The printing control unit 14 controls a printing unit 160 of the printing apparatus 100. For example, the printing control unit 14 transmits a print image P (see FIG. 3), the test print images T1 to T3, the printing conditions, and the like to the printing unit 160.

The storage unit 20 includes, for example, a memory such as a read only memory (ROM) that is a read-only semiconductor memory in which a predetermined control program is recorded in advance, a random access memory (RAM) that is a semiconductor memory which is used as a working storage area as necessary when the processor executes various control programs and is writable and readable at any time, a hard disk device, and the like.

The storage unit 20 stores the characteristic information table 21. This characteristic information table 21 indicates a correlation between the printing conditions (the amount of the white ink, the amount of the pretreatment liquid, etc.) and the characteristic information of the printed material (fastness to washing, white density, etc.) for each base material M (preferably, each of the material of the cloth of the base material M and the color of the cloth). By having the characteristic information table 21, the storage unit 20 functions as an example of a correlation storage unit that stores a correlation between a printing condition and a characteristic condition. Note that, the correlation storage unit may be arranged in a device different from the printing control apparatus 1.

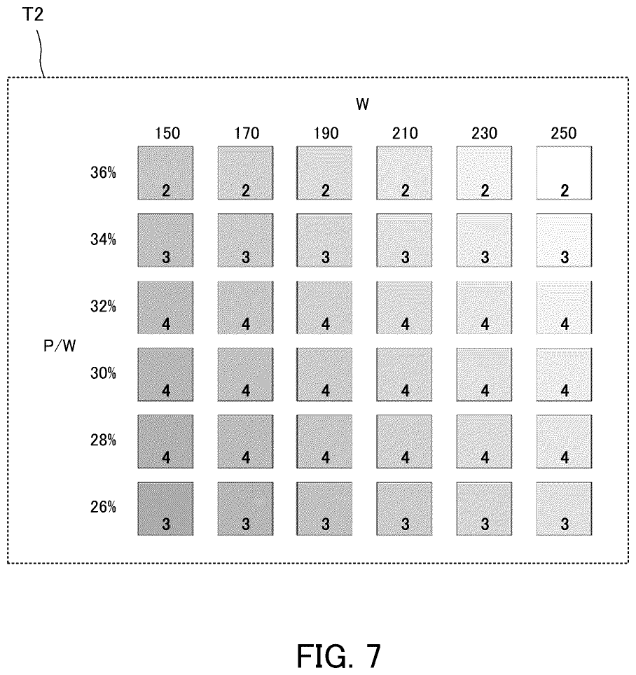

The display unit 30 is a display that displays various types of information. For example, the display unit 30 displays the test print screen 31 illustrated in FIG. 3, the advanced setting screens 32 and 33 illustrated in FIGS. 4 and 5, the test print images T1 and T2 illustrated in FIGS. 6 and 7, and the like under the control of the display control unit 13.

The input unit 40 is an operation key, a touch panel, or the like that receives inputs of various types of information.

The interface unit 50 exchanges various types of information with various devices such as the printing apparatus 100 connected wirelessly or by wire via a network.

The printing apparatus 100 illustrated in FIG. 1 includes a control unit 110, a storage unit 120, a display unit 130, an input unit 140, an interface unit 150, the printing unit 160, and a stage 170 (see FIG. 2).

The control unit 110 includes, for example, one or more processors (such as a CPU) functioning as an arithmetic processing device that controls the operation of each unit of the printing apparatus 100. The storage unit 120 includes, for example, a memory such as a ROM that is a read-only semiconductor memory in which a predetermined control program is recorded in advance, a RAM that is a semiconductor memory which is used as a working storage area as necessary when the processor executes various control programs and is writable and readable at any time, a hard disk device, and the like. The display unit 130 is a display that displays various types of information. The input unit 140 is an operation key, a touch panel, or the like that receives inputs of various types of information. The interface unit 150 exchanges various types of information with various devices such as the printing control apparatus 1 connected wirelessly or by wire via a network.

As illustrated in FIG. 2, the printing unit 160 includes multiple heads 161p, 161w, 161k, 161c, 161m, and 161y.

The head 161p discharges the pretreatment liquid onto the base material M placed on the stage 170. Note that, the base material M is, for example, a fabric such as a cloth or woven fabric. The pretreatment liquid is not particularly limited as long as it is supplied to the base material M before printing of the color ink, and its examples include liquid containing an aggregating agent such as a polyvalent metal salt, an organic acid, a cationic polymer, or a cationic surfactant, which reacts with ink to aggregate the ink.

The head 161w ejects the white ink, which is an example of the base ink. For example, the head 161w ejects the white ink after the head 161p ejects the pretreatment liquid. After the pretreatment liquid and the white ink are discharged, the heads 161k, 161c, 161m, and 161y discharge color inks of black, cyan, magenta, and yellow, respectively. Here, the reason why the white ink is printed as a base is to reduce the influence of the color of the base material M on the image formed with the color ink even if the base material M has a dark color such as black or dark blue. For example, when an image is formed using the color ink on a black cloth without a white layer, the image becomes blackish as compared with the case where the image is formed on a white cloth.

Note that, the ink may be applied to the cloth, to which the pretreatment liquid has been applied, by a so-called wet-on-wet method without going through a drying step, or the ink may be applied after the cloth to which the pretreatment liquid has been applied is dried. However, it is preferable that the white ink is applied to the base material by a wet-on-wet method after the pretreatment liquid is attached to form a white image, and the non-white ink is further applied by a wet-on-wet method to form a non-white image. The white ink and the color ink can be fixed to the base material M by drying the base material M at a high temperature after discharge of the pretreatment liquid, the white ink, and the color ink by the printing unit 160.

FIG. 3 is a diagram illustrating the test print screen 31.

The test print screen 31 illustrated in FIG. 3 is an example of a screen displayed on the display unit 30 under the control of the display control unit 13 illustrated in FIG. 1, and is a screen for performing test printing. In the setting field of the test print screen 31, the material of the cloth and the color of the cloth are selected as the information of the base material M. For example, the material of the cloth is sparse polyester, dense polyester, cotton, or the like, and the color of the cloth is black, blue, red, yellow, or the like. In addition, in the setting field on the test print screen 31, the grade of the fastness to washing desired by the user is selected from, for example, “grade 4”, “grade 3-4”, and “not specified”. When the grade of the fastness to washing (“grade 4” or “grade 3-4”) is selected, only the printing condition satisfying the input fastness to washing may be included in the recommended setting range of the amounts of the white ink and the pretreatment liquid to be described later.

In the “amount of white ink” and the “amount of pretreatment liquid” (e.g., the ratio between the pretreatment liquid and the white ink) in the setting field on the test print screen 31, a range (e.g., 150˜250 or 26˜36) and an interval (e.g., Step 20 or Step 2) to be subjected to test printing are input. In this range, a recommended setting range may be input in advance. This recommended setting range varies depending on the material and color of the base material M. The recommended setting range of the amounts of the white ink and the pretreatment liquid may be empirically obtained by actually washing and performing a durability test. In addition, a prescribed value of the interval may be input in advance. Even if the range and the interval are input in advance, the user can appropriately change the range and the interval by inputting a numerical value, for example.

The “advanced setting” button in the setting field of the test print screen 31 is for setting conditions for test printing in more detail, and when the advanced setting button is pressed down, the advanced setting screen 32 illustrated in FIG. 4 is displayed on the display unit 30, for example.

The condition selection image 32a of the advanced setting screen 32 illustrated in FIG. 4 is a table of characteristic information corresponding to the printing conditions of the combination of the amount of the white ink and the amount of the pretreatment liquid, and is an example of a characteristic information image representing the characteristic information for each of the multiple printing conditions. In the example of FIG. 4, the condition selection image 32a is an image obtained when sparse polyester is selected as the material of the cloth of the base material M (the color of the base material M is black, for example).

Note that, in the condition selection image 32a, the amount of the white ink is set at intervals of 20 so as to correspond to Step 20 illustrated in FIG. 3. The amount of the pretreatment liquid is set at intervals of 2% so as to correspond to Step 2 illustrated in FIG. 3. The amount of the pretreatment liquid may be set as standard, +1, +2, +3, . . . , −1, −2, −3, . . . in a manner different from the example illustrated in FIG. 3. In this case, “+” and “−” represent an approximate increase or decrease of the amount with respect to the standard amount, and may be internally associated with the amount of the pretreatment liquid illustrated in FIG. 3 such as standard=30, +1=32, and −1=28.

In each printing condition, a guide of the fastness to washing (Grade 2, 3, or 4) is displayed at the upper stage, and a guide of the white density is displayed at the lower stage. The fastness to washing and the white density displayed here are experimental values in a standard cloth, and thus may differ when printing is actually performed depending on the characteristics of the cloth. However, since the user can select the printing conditions of the test printing after knowing the tendency before printing, the user can narrow down the necessary conditions more easily.

In the condition selection image 32a, only the printing conditions represented by the dot pattern background are in the selected state of the test printing target. The printing conditions in the selected state may be determined in advance based on, for example, the range of the amount of the white ink and the range of the amount of the pretreatment liquid illustrated in FIG. 3. Note that, the range of the selected state may be switched between the selected state and the non-selected state by pressing a field of each condition, for example. Actually, since the number of conditions that can be printed by one test printing is limited, it is important to narrow down the conditions to a certain range in advance. Note that, in a case where the user selects all the printing conditions under which the fastness to washing satisfies a desired standard, the test printing range is wide from a portion where the white density is low to a portion where the white density is high, but the white hiding ratio is insufficient at a portion where the white is light, and thus it is meaningless for many users. Thus, it is preferable that the printing conditions are selected not only based on the fastness to washing but also based on the white density, or the printing conditions of the white density (the amount of the white ink) equal to or less than the prescribed value are excluded from the condition selection image 32a.

The printing conditions displayed as the condition selection image 32a are preferably such that the displayable range can be adjusted with a scroll bar vertically and horizontally. Note that, although the number of printing conditions in the selected state illustrated in FIG. 4 is 30, this number can be any number as long as it is equal to or less than the upper limit number that allows test printing.

Note that, when the selected state and the non-selected state are switched under at least one printing condition, thereafter, after the “OK” button illustrated in FIG. 4 is pressed down, the check box field on the left side of the advanced setting button is checked as illustrated in FIG. 3.

In the advanced setting screen 33 of FIG. 5 which is an example different from the advanced setting screen 32 of FIG. 4, the fastness to washing is written in the field of the “amount of pretreatment liquid” together, and the fastness to washing is not displayed in the field of each printing condition and its upper part is blank. In this blank field, characteristic information different from the fastness to washing and the white density (such as the fastness to rubbing, the texture, the cost, the total usage amount of the pretreatment liquid and the white ink) may be displayed.

Returning to FIG. 3, the print image P (original) to be subjected to the test printing can be read in the field of the “print image” on the test print screen 31. The file format is, for example, image data (not limited to PDF, JPEG, PNG or the like may be used) such as “ABC.pdf”, and the print image P may be adjusted by functions such as scaling and trimming although not illustrated.

In the “message” field of the test print screen 31, a notice is displayed when the range of the amount of the white ink or the amount of the pretreatment liquid set by the user in the above-described setting field is outside the recommended setting range. For example, in the example of FIG. 3, since the amount of the pretreatment liquid (for example, the ratio between the pretreatment liquid and the white ink) is input as 26-36, which exceeds the recommended setting range of 18-33, “The ratio between the white ink and the pretreatment liquid is not appropriate.” is displayed. Note that, depending on the cloth used by the user, values outside the recommended setting range may bring a better balance in image quality and fastness, and thus the message merely gives notice.

When the “print” button on the test print screen 31 is pressed, the test print images T1 to T3 illustrated in FIGS. 6 to 8 are generated in the ranges and intervals of the printing conditions described above. When the “cancel” button is pressed, test printing is not performed.

The test print image T1 illustrated in FIG. 6 is an image to be printed on the base material M. This test print image T1 may be displayed on the display unit 30 under the control of the display control unit 13 before printing. In addition, the test print image T1 may be an image that is only displayed on the display unit 30 without being printed.

In the test print image T1, the amount is displayed for each of the printing conditions of combinations of the amount of the white ink (W) (150, 170, 190, 210, 230, 250) and the amount of the pretreatment liquid (P/W, which is the ratio between the pretreatment liquid and the white ink, =36%, 34%, 32%, 30%, 28%, 26%), and the print image P (face image and characters of “abcde”) and the fastness to washing “2”, “3”, or “4” are displayed in a table format arranged vertically and horizontally. The white density corresponding to each printing condition is represented by the shade of the background color of a rectangular region. Here, a color having a darker background color indicates a lower white density, and a color having a brighter background color indicates a higher white density. Note that, a broken line around the test print image T1 merely represents a peripheral edge of the test print image T1.

The test print image T2 illustrated in FIG. 7 is obtained by removing the print image P from the portion corresponding to each printing condition of the test print image T1 illustrated in FIG. 6. As described above, the print image P does not necessarily have to be included in the test print image T2.

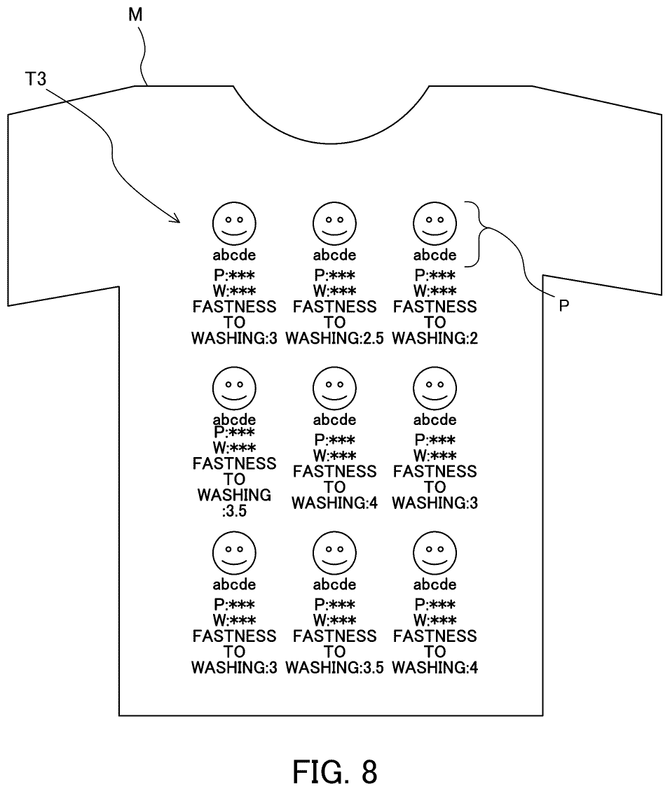

FIG. 8 illustrates the test print image T3 printed on the base material M. Unlike the test print images T1 and T2 in FIGS. 6 and 7, this test print image T3 has printing conditions represented by the amounts of the pretreatment liquid (P) and the white ink (W) (indicated by “***” in FIG. 8). In addition, in each printing condition, the print image P and the fastness to washing are represented.

Note that, the layouts of the test print images T1 to T3 illustrated in FIGS. 6 to 8 are examples, and the layouts may be optimized by the size of the printing region, the size of the image, the number of conditions, and the like. In addition, in the present embodiment, the test print images T1 to T3 illustrated in FIGS. 6 to 8 are generated, but the condition selection images 32a and 33a illustrated in FIGS. 4 and 5 also represent the characteristic information such as the fastness to washing and the white density of the printed material similarly to the test print images T1 to T3, and thus serve as references when the user selects the printing conditions. Thus, the generation of the test print images T1 to T3 may be omitted.

In the present embodiment described above, the printing control apparatus 1, which is an example of an image processing apparatus, includes: the characteristic information extraction unit 11 that extracts the characteristic information (such as the fastness to washing and the white density) of the printed material corresponding to the base material M used for printing using the pretreatment liquid, the white ink (an example of the base ink), and the color ink and the printing conditions of the printing (such as the amount of the white ink and the amount of the pretreatment liquid); and the image generation unit 12 that generates the characteristic information image (such as the condition selection images 32a and 33a and the test print images T1 to T3) representing the characteristic information extracted by the characteristic information extraction unit 11.

In terms of a printing control method (an example of an image processing method), the printing control method performed by a computer (such as the control unit 10 and the printing control apparatus 1) includes: extracting the characteristic information (such as the fastness to washing and the white density) of the printed material corresponding to the base material M used for printing using the pretreatment liquid, the white ink (an example of the base ink), and the color ink and the printing conditions of the printing (such as the amount of the white ink and the amount of the pretreatment liquid); and generating the characteristic information image (such as the condition selection images 32a and 33a and the test print images T1 to T3) representing the extracted characteristic information.

In terms of a program, the program causes a computer (such as the control unit 10 and the printing control apparatus 1) to implement functions of: extracting the characteristic information (such as the fastness to washing and the white density) of the printed material corresponding to the base material M used for printing using the pretreatment liquid, the white ink (an example of the base ink), and the color ink and the printing conditions of the printing (such as the amount of the white ink and the amount of the pretreatment liquid); and generating the characteristic information image (such as the condition selection images 32a and 33a and the test print images T1 to T3) representing the extracted characteristic information.

In the printing control apparatus 1, the printing control method, and the program, the characteristic information of the printed material corresponding to the printing conditions can be presented to the user by the characteristic information images such as the condition selection images 32a and 33a and the test print images T1 to T3. Thus, the user can check the characteristic information of the printed material that cannot be checked unless printing is actually performed, such as the fastness to washing of the printed material and the white density of the printed material corresponding to the printing conditions such as the amount of the white ink and the pretreatment liquid. Thus, according to the present embodiment, it is possible to facilitate user's selection of printing conditions for a desired printed material.

In addition, in the present embodiment, the characteristic information images representing the characteristic information are the test print images T1 to T3 printed by test printing.

Thus, by viewing the printed material on which the test printing of the test print images T1 to T3 has been performed, the user can easily check the characteristic information of the printed material as compared with the case of checking the characteristic information on the screen such as the display unit 30, for example. Accordingly, it is possible to further facilitate user's selection of printing conditions for a desired printed material. Note that, since the manufacturer uses the characteristic information as a guide of conditions for a standard cloth, it is possible to check, by the printed material, a difference due to conditions such as the thickness of the actual cloth and the dye used for coloring.

Further, in the present embodiment, the image generation unit 12 presents, to the user, the characteristic information image (such as the condition selection images 32a and 33a) different from the test print images T1 to T3 and corresponding to the multiple printing conditions, and generates the test print images T1 to T3 corresponding to one or more printing conditions among the multiple printing conditions selected by the user.

As a result, the user can select the printing condition of the test printing target while viewing the characteristic information image such as the condition selection images 32a and 33a, and thus, it is possible to generate the test print images T1 to T3 corresponding only to the printing condition under which the characteristic information desired by the user can be obtained.

In addition, in the present embodiment, for example, the image generation unit 12 presents multiple printing conditions, recommended in the recommended setting range, to the user, and generates the characteristic information image (such as the condition selection images 32a and 33a and the test print images T1 to T3) corresponding to one or more printing conditions among the multiple printing conditions selected by the user.

Thus, the user can select a printing condition from among multiple recommended printing conditions. Accordingly, it is possible to further facilitate user's selection of printing conditions for a desired printed material.

Further, in the present embodiment, the characteristic information of the printed material includes at least one of the fastness to washing and the white density.

As a result, the user can check, from the characteristic information image, the fastness to washing which cannot be checked even when viewing the printed material actually printed and the white density which is an important parameter for determining the image quality. Accordingly, it is possible to further facilitate user's selection of printing conditions for a desired printed material.

Note that, the present invention is not limited to the above-described embodiment as it is, and the constituents can be modified and embodied without departing from its gist at the implementation stage. In addition, various inventions can be formed by appropriately combining the multiple constituents disclosed in the above-described embodiments. For example, all the constituents illustrated in the embodiment may be appropriately combined. It is a matter of course that various modifications and applications can be made without departing from the gist of the invention. Hereinafter, some inventions described in the specification of the present application will be additionally described.

According to an aspect, an image processing apparatus includes a processor being configured
to extract characteristic information of a printed material corresponding to a base material used for printing using pretreatment liquid, base ink, and color ink and a printing condition of the printing, and
to generate a characteristic information image representing the extracted characteristic information.

According to another aspect, the characteristic information image is a test print image printed by test printing.

According to another aspect, the processor presents the characteristic information image different from the test print image and corresponding to the multiple printing conditions to a user, and generates the test print image corresponding to one or more of the multiple printing conditions selected by the user.

According to another aspect, the processor presents the multiple recommended printing conditions to the user, and generates the characteristic information image corresponding to one or more of the multiple printing conditions selected by the user.

According to another aspect, the characteristic information includes at least one of fastness to washing and white density.

According to another aspect, an image processing method performed by a computer, includes:
extracting characteristic information of a printed material corresponding to a base material used for printing using pretreatment liquid, base ink, and color ink and a printing condition of the printing; and
generating a characteristic information image representing the extracted characteristic information.

According to another aspect, a non-transitory storage medium stores a program for causing a computer to execute a process comprising:
extracting characteristic information of a printed material corresponding to a base material used for printing using pretreatment liquid, base ink, and color ink and a printing condition of the printing; and
generating a characteristic information image representing the extracted characteristic information.

What is claimed is:

1. An image processing apparatus comprising a processor being configured
to extract characteristic information of a printed material corresponding to a base material used for printing using pretreatment liquid, base ink, and color ink and a printing condition of the printing, and
to generate a characteristic information image representing the extracted characteristic information.

2. The image processing apparatus according to claim 1, wherein
the characteristic information image is a test print image printed by test printing.

3. The image processing apparatus according to claim 2, wherein
the processor presents the characteristic information image different from the test print image and corresponding to a plurality of the printing conditions to a user, and generates the test print image corresponding to one or more of the plurality of printing conditions selected by the user.

4. The image processing apparatus according to claim 1, wherein
the processor presents a plurality of the recommended printing conditions to a user, and generates the characteristic information image corresponding to one or more of the plurality of printing conditions selected by the user.

5. The image processing apparatus according to claim 1, wherein
the characteristic information includes at least one of fastness to washing and white density.

6. An image processing method performed by a computer, comprising:
extracting characteristic information of a printed material corresponding to a base material used for printing using pretreatment liquid, base ink, and color ink and a printing condition of the printing; and
generating a characteristic information image representing the extracted characteristic information.

7. A non-transitory storage medium storing a program for causing a computer to execute a process comprising:
extracting characteristic information of a printed material corresponding to a base material used for printing using pretreatment liquid, base ink, and color ink and a printing condition of the printing; and
generating a characteristic information image representing the extracted characteristic information.
